(19) United States
(12) Patent Application Publication
(10) Pub. No.: US 2024/0344704 A1
(43) Pub. Date: Oct. 17, 2024

(54) HYBRID FIREPLACE WITH DISPLAY

(71) Applicant: HNI Technologies Inc., Muscatine, IA (US)

(72) Inventors: Benjamin Allen Skibsted, Pine Island, MN (US); Andrew Arthur Clemenson, Zumbrota, MN (US); David Charles Lyons, Redwing, MN (US); Louis Lavern Mead, Lake City, MN (US)

(21) Appl. No.: 18/634,509

(22) Filed: Apr. 12, 2024

Related U.S. Application Data
(60) Provisional application No. 63/459,440, filed on Apr. 14, 2023.

(51) Int. Cl. F24C 3/00; F21S 10/04; F24H 3/02

(52) U.S. Cl. CPC F24C 3/006; F21S 10/04; F24H 3/025

(57) ABSTRACT

A fireplace assembly includes: a housing defining an airflow space and an inner chamber; one or more fans disposed in the housing to facilitate airflow through the airflow space; a flame generator disposed in the inner chamber and capable of generating a flame with a maximum heat output of at least 20,000 BTU (British thermal units); a display device disposed in the housing and configured to display a visual image in front of or behind the flame generator; one or more glass panels disposed in the housing to at least partially define the airflow space to facilitate the airflow; and a control module operatively coupled with the display device and disposed within the airflow space. The airflow through the airflow space is configured to control temperature within the airflow space.

### CROSS-REFERENCE TO RELATED APPLICATION

This application claims priority to U.S. Provisional Application No. 63/459,440, filed on Apr. 14, 2023, the disclosure of which is incorporated herein by reference in its entirety for all purposes.

### FIELD

The present disclosure relates generally to fireplaces, and more specifically to hybrid fireplaces with features and capabilities of electric fireplaces and gas fireplaces.

### BACKGROUND

Fireplaces include those that are fueled by gas, such as gas fireplaces, and those that are electrically powered, such as electric fireplaces. Users of a gas fireplace can turn down or turn off the gas that is supplied to the fire if the temperature generated by the fire becomes too hot, since a typical heat output of a gas fireplace can reach 20,000 BTU (British Thermal Units) or above. An electric fireplace, on the other hand, does not reach the heat output that the gas fireplace can provide, generally around 5,000 BTU, and as such, it may be preferred by users who may not need to generate such a high heat output.

However, despite not needing as high a heat output as a gas fireplace, users of electric fireplaces may also want to experience the flames that are generated by a gas fireplace. As such, there is a need for improvements in fireplaces that can implement benefits from both types of fireplaces.

### SUMMARY

According to one embodiment, a fireplace assembly includes: a housing defining an airflow space and an inner chamber; one or more fans disposed in the housing to facilitate airflow through the airflow space; a flame generator disposed in the inner chamber and capable of generating a flame with a maximum heat output of at least 20,000 BTU (British Thermal Units) or 21.1 MJ (megajoules); a display device disposed in the housing and configured to display a visual image in front of or behind the flame generator; one or more glass panels disposed in the housing to at least partially define the airflow space to facilitate the airflow; and a control module operatively coupled with the display device and disposed within the airflow space. The airflow through the airflow space is configured to control temperature within the airflow space.

According to embodiments disclosed herein, a fireplace assembly includes: a housing defining an airflow space and an inner chamber; one or more fans disposed in the housing to facilitate airflow through the airflow space; a flame generator disposed in the inner chamber and capable of generating a flame with a maximum heat output of at least 20,000 BTU or 21.1 MJ; a display device disposed in the housing and configured to display a visual image in front of or behind the flame generator; one or more glass panels disposed in the housing to at least partially define the airflow space to facilitate the airflow; and a control module operatively coupled with the display device and disposed within the airflow space. The airflow through the airflow space is configured to control temperature within the airflow space.

In some examples, the visual image is an image of a simulated flame with a heat output of greater than the maximum heat output of the flame generator. In some examples, the flame generator includes a fuel source, a pilot, and a burner. In some examples, the fuel source uses any one or more of: gas, electricity, flammable gel, ethanol, or biofuel.

In some examples, the assembly may further include a floor shield disposed in the inner chamber. The control module is operatively coupled with one or more lights disposed underneath the floor shield. In some examples, the housing includes an inflow vent and an outflow vent. In some examples, a floor of the inner chamber is aligned with the inflow vent. In some examples, the floor of the inner chamber is level with an upper part of the inflow vent.

In some examples, the housing includes a glass air shield disposed at a front portion of the housing. In some examples, a floor of the inner chamber is aligned with a bottom portion of the glass air shield. In some examples, a floor of the inner chamber is disposed below a bottom portion of the glass air shield. In some examples, the housing includes a mesh door disposed at a front portion of the housing. In some examples, the housing includes a power source for the display device and the control module.

In some examples, the assembly may further include a fire media tray disposed in the housing, and fire media disposed in the fire media tray. In some examples, the one or more glass panels includes a plurality of glass panels that are disposed such that a space between two of the plurality of glass panels defines a portion of the airflow space and the airflow is facilitated between the two of the plurality of glass panels.

In some examples, the assembly may further include a receiver operatively coupled with the control module and configured to receive wireless data signals from a remote controller. In some examples, the control module includes a processing unit and a memory unit. The processing unit is operatively coupled with the flame generator and the display device, and the processing unit determines the visual image based upon an actual amount of heat output of the flame generator.

According to embodiments disclosed herein, a method of displaying a visual image of a simulated flame includes: detecting, by a control module of a fireplace assembly, a heat output of a flame generator of the fireplace assembly; determining, by the control module, the visual image of the simulated flame based on the detected heat output; and transmitting, by the control module to a display device, instructions for the display device to display the visual image.

In some examples, the simulated flame is a simulation of a flame having a heat output that is greater than the heat output of the flame generator that is detected by the control module. In some examples, the simulated flame has a heat output of greater than 20,000 BTU or 21.1 MJ.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a cross-sectional schematic view of a hybrid fireplace according to various embodiments disclosed herein.

FIG. 2 is a cross-sectional schematic view of another hybrid fireplace according to various embodiments disclosed herein.

FIG. 3 is a cross-sectional schematic view of another hybrid fireplace according to various embodiments disclosed herein.

FIG. 4 is a front view of a hybrid fireplace according to various embodiments disclosed herein.

FIG. 5 is a schematic diagram of the components of a hybrid fireplace assembly according to various embodiments disclosed herein.

FIG. 6 is a flowchart of a method or process implemented by a controller of a hybrid fireplace assembly according to various embodiments disclosed herein.

FIG. 7 is a cross-sectional schematic view of another hybrid fireplace according to various embodiments disclosed herein.

### DETAILED DESCRIPTION

The present disclosure is generally directed to a fireplace assembly which provides a hybrid fireplace that has the capability of generating a flame with a maximum heat output of at least 20,000 BTU (British Thermal Units) or 21.1 MJ (megajoules), while also providing a visual display of a larger flame behind the generated flame, for example. In some examples, the maximum heat output may be greater.

A fireplace assembly as disclosed herein may combine the functionality of an electric fireplace with a heating capability of a gas fireplace, thus forming a hybrid fireplace. The fireplace assembly may include a housing which has an inflow vent and an outflow vent as well as an airflow space located internal to the housing allowing airflow from the inflow vent to the outflow vent. The housing may also include an inner chamber in which a flame can be lit using gas or electric means, including, for example, an electronic ignition, hot surface ignition, or standing pilot light ignition. The housing may also include a mesh door and a glass air shield for protection and/or for stabilizing flame aesthetics. The floor of the inner chamber may be protected using a floor shield such as a heat-resistant protection panel. The floor may also hold fire media.

The housing of the fireplace assembly may include therein multiple components. For example, there may be fans to drive the airflow in a direction from the inflow vent to the outflow vent through the airflow space. LED lights may be included to provide lighting from the floor of the inner chamber as controlled by a control module. Operation of a flame generator such as a gas pilot burner, for example a burner and a pilot, may be controlled using a control valve coupled with the fuel source. A display may be provided at the back of the fireplace assembly. The control module and the display may be powered via an AC power source.

The fireplace assembly may have one or more glass panels, for example heat-resistant glass protectors, disposed between the inner chamber and the display so as to protect the display from the heat emitted by the flame inside the inner chamber.

Airflow is provided throughout the airflow space, including between the glass panels, between the glass panel and the display, and behind the display, for example. The airflow may assist in controlling the temperature within the airspace so as to cool the electrical components such as the LED lights, the control module, the display, and the AC power source so as to prevent them from overheating.

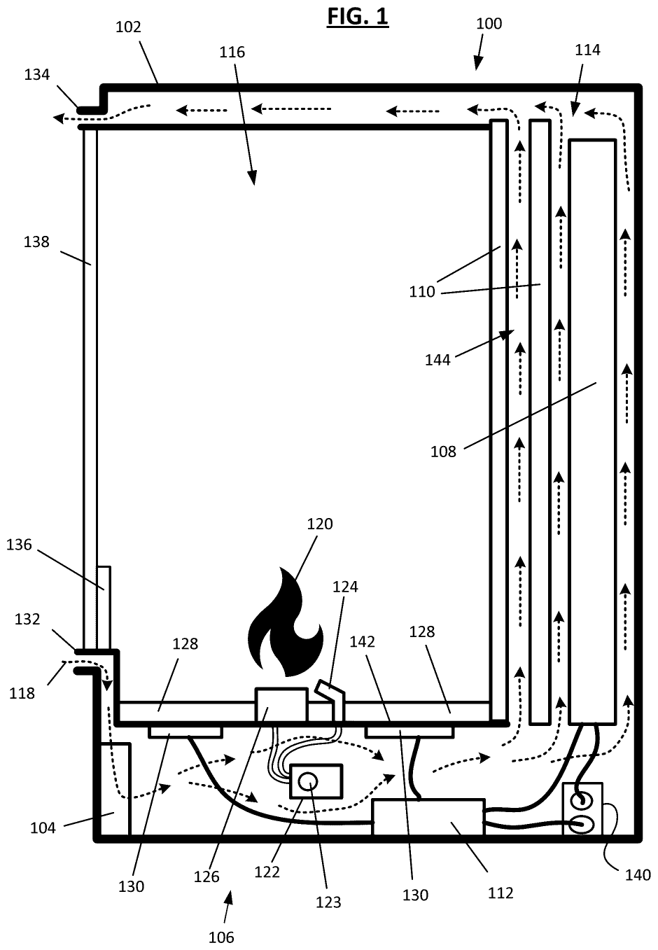

FIGS. 1-4 and 7 each shows an example of a fireplace assembly 100 according to embodiments disclosed herein. Referring to FIGS. 1-3, the assembly 100 includes a housing 102, one or more fans 104, a flame generator 106, a display device 108, one or more glass panels 110, and a control module 112 such as an electronic controller. The housing 102 defines an airflow space 114 and an inner chamber 116 inside the housing 102. The one or more fans 104 are disposed in the housing 102 to facilitate airflow 118 (shown using dotted arrows) through the airflow space 114.

The flame generator 106 is disposed in the inner chamber 116 and capable of generating a flame 120 with a heat output of from about 0 BTU (British thermal unit) or 0 J (joule) to at least 20,000 BTU or about 21.1 MJ (megajoules), such as from 0 BTU to 100 BTU (or about 0.1 MJ), from 100 BTU to 500 BTU (or about 0.53 MJ), from 500 BTU to 1,000 BTU (or about 1.06 MJ), from 1,000 BTU to 5,000 BTU (or about 5.28 MJ), from 5,000 BTU to 10,000 BTU (or about 10.6 MJ), from 10,000 BTU to 15,000 BTU (or about 15.8 MJ), from 15,000 BTU to 20,000 BTU (or about 21.1 MJ), or from 20,000 BTU to any suitable value greater than 20,000 BTU such as 25,000 BTU (or about 26.4 MJ), 30,000 BTU (or about 31.6 MJ), 40,000 BTU (or about 42.3 MJ), or 50,000 BTU (or about 52.8 MJ), or any other value therebetween or combination of ranges thereof. In some examples, when the heat output is 0 BTU, the flame generator 106 is turned off or is not generating any heat. In some examples, the maximum heat output of the flame generator 106 may be at least 20,000 BTU, 30,000 BTU, 40,000 BTU, 50,000 BTU, or any other suitable value or range therebetween.

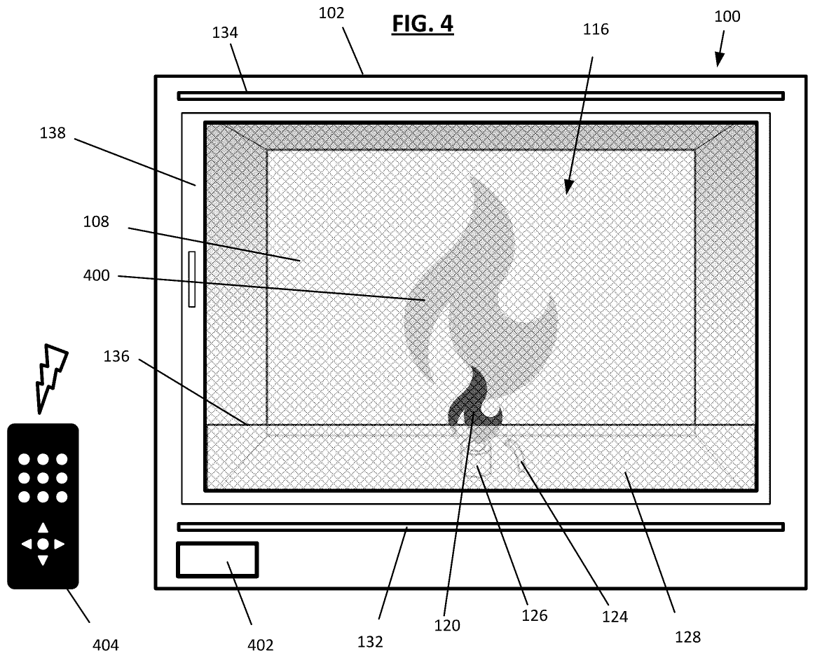

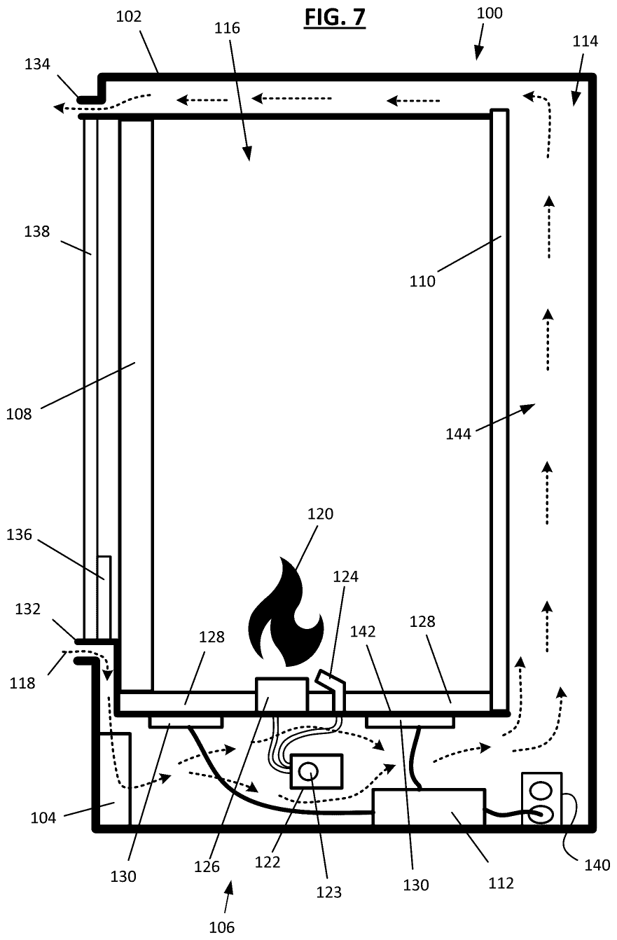

The display device 108 is disposed in the housing 102 and configured to display a visual image 400 (an example of which is shown in FIG. 4) either in front of or behind the flame generator 106. FIG. 7, for example, shows the display device 108 positioned in front of the flame generator 106, whereas FIGS. 1-4 show the display device 108 positioned behind the flame generator 106. The display device 108 may be any suitable electronic display that shows images, such as an LED display or screen.

The one or more glass panels 110 are disposed in the housing 102 to at least partially define the airflow space 114 to facilitate the airflow 118 therethrough. In some configurations, a single glass panel 110 may be placed in the housing 102 (such as in FIG. 7), and in some configurations, two or more glass panels 110 may be placed in the housing 102 (such as in FIGS. 1-3). Any other number of glass panels may be implemented as suitable. For example, the glass panels 110 may be placed between the inner chamber 116 and the display device 108 such that the airflow 118 is facilitated between one or more of the glass panels 110 and the display device 108. The control module 112 is operatively coupled with the display device 108 and disposed within the airflow space 114. The airflow 118 through the airflow space 114 is configured to control a temperature within the airflow space 114.

In some examples, the visual image 400 may be an image of a simulated flame with a heat output of greater than 20,000 BTU or 21.1 MJ. In some examples, the visual image 400 may be an image of a simulated flame that has a heat output that is greater than the heat output of the actual flame 120 that is generated by the flame generator 106, such that the visual image 400 creates a perception of the fireplace assembly 100 providing a larger flame than is actually being generated by the flame generator 106. This may be beneficial when users of the fireplace assembly 100 prefers seeing a larger flame but do not wish to actually have such flame being generated, for example when the fireplace assembly is located in a smaller room or when the users wish to keep the room cooler but still see a larger flame for aesthetic purposes.

The flame generator 106 may be any suitable device that is capable of generating a flame that has a predetermined heat output that can be controlled by the users of the fireplace assembly 100. In some examples, the flame generator 106 may be operated electrically or via the use of a fuel, which may be stored in a fuel source 122. The fuel may include any one or more of: gas, electricity, flammable gel, ethanol, and/or biofuel, among others.

The fuel source 122 may have a control valve 123 to operate the fuel source 122 such as by turning it on/off and controlling the heat output of the flame 120 that is generated. The fuel source 122 may be used together with a pilot 124 or a pilot assembly, and a burner 126, which may also be part of the flame generator 106. The pilot 124 may generate a pilot light, or a small flame that is kept lit in a gas fireplace such that, when the fuel source 122 is turned on, fuel (which in this case may be gas) is released from the fuel source 122 to the burner 126, and the pilot light from the pilot 124 ignites the fuel to generate the flame 120 and provide heat.

In some examples, the housing 102 includes a floor shield 128 that is disposed in the inner chamber 116. The control module 112 may be operatively coupled with one or more lights 130, such as LED lights, that are disposed underneath the floor shield 128 so as to provide lighting from beneath the flame 120 to increase the brightness of the flame 120, for example. The floor shield 128 may be made of any suitable material that limits the amount of heat transfer from the inner chamber 116, such as near the flame 120, to the lower portion of the airflow space 114 within the housing 102. Similarly, the glass panels 110 may also be made of any suitable material such as heat resistant glass that limits the amount of heat transfer, and the material of the glass panels 110 is transparent to allow the users to see the visual image(s) 400 shown on the display device 108 located behind the glass panels 110.

In some examples, the housing 102 includes an inflow vent 132 and an outflow vent 134 through which the airflow 118 is facilitate to pass, specifically from the inflow vent 132 toward the outflow vent 134. The one or more fans 104 may provide the direction in which the airflow 118 passes through the airflow space 114 defined by the housing 102. In some examples, the housing 102 includes a glass air shield 136 that is disposed at a front portion of the housing 102. In some examples, the housing 102 includes a mesh door 138 that is disposed at a front portion of the housing 102. The glass air shield 136 may be disposed at a lower portion at the front portion than the mesh door 138, such that the glass air shield 136 primarily acts as a barrier to protect the flame 120 from reaching the floor or ground outside of the assembly 100.

In some examples, the housing 102 includes a power source 140 for the display device 108 and the control module 112. For example, the power source 140 may be a power outlet being accessible by the display device 108 and the control module 112 that provides the necessary electrical power to operate such electronic devices. In some examples, the power source 140 may include a high voltage or low voltage power source, including but not limited to one or more batteries with the appropriate voltage level. In some examples, a plurality of glass panels 110 are disposed in the housing 102 such that a space 144 between two of the glass panels 110 defines a portion of the airflow space 114, and the airflow 118 is facilitated between two of the glass panels 110.

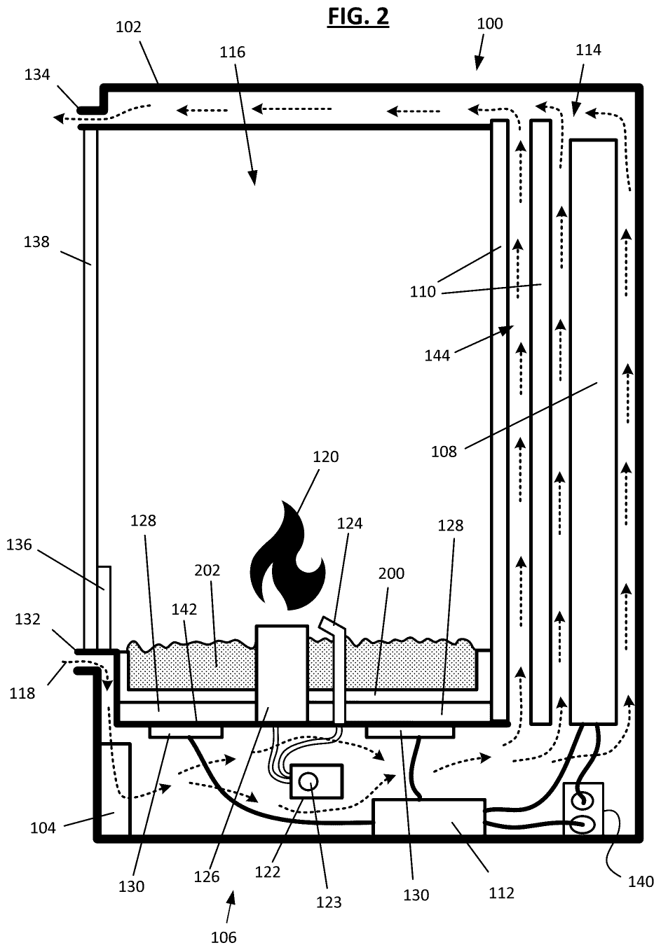

In FIGS. 1 and 2, the fireplace assembly 100 may be provided such that a floor 142 of the inner chamber 116 forms a depression with respect to (or is disposed below) the bottom portion of the glass air shield 136 or is positioned lower than the inflow vent 132.

In FIG. 2, the housing 102 further includes a fire media tray 200 that is disposed in the housing 102, such as on the floor 142 of the inner chamber 116. The tray 200 contains fire media 202 disposed therein. Examples of fire media 202 (or fireplace media) include but are not limited to: fire glass, fire stones, lava rocks, gas logs, and any other suitable components, for decorative or aesthetic purposes. The fire media 202 is disposed in the depression formed in the inner chamber 116 with respect to the bottom portion of the glass air shield 136 or the upper portion of the inflow vent 132. In some examples, the fire media 202 may be disposed directly on the floor 142 or on the floor shield 128 instead of on the fire media tray 200.

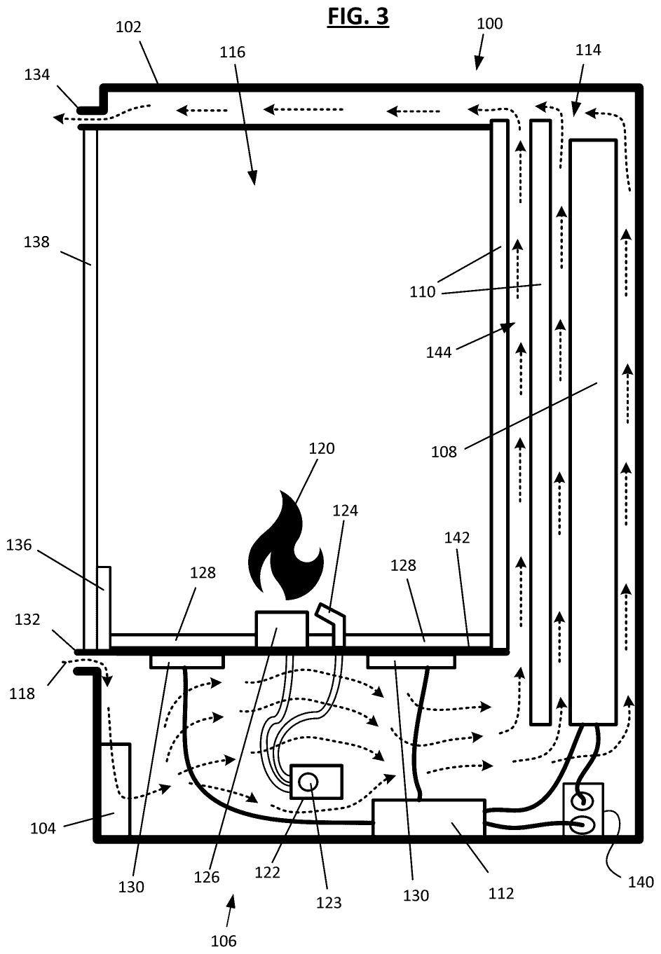

In FIG. 3, the floor 142 of the inner chamber 116 is aligned with the bottom portion of the glass air shield 136, or is positioned to align with the inflow vent 132. In some examples, the floor of the inner chamber is level with or aligned with an upper part of the inflow vent 132. Additional inner volume is provided for the airflow space 114 underneath the floor 142 of the inner chamber 116.

In FIG. 7, the display device 108 is positioned in front of the flame generator 106, such as between the mesh door 138 and the flame generator 106, so as to display the visual image 400 in front of the actual flame 120. The glass panel 110 is positioned behind both the flame generator 106 and the display device 108 and in front of a back portion of the housing 102 to at least partially define the airflow space 114 through which the airflow 118 is facilitated. In some examples, an additional glass panel 110 may be positioned between the back of the display device 108 and the flame generator 106 so as to protect the display device 108 from the heat output of the flame generator 106.

FIG. 4 shows a front view of the fireplace assembly 100. The assembly 100 may be any one or more of the assemblies shown in FIGS. 1-3, for example. The assembly 100 has the display device 108 which shows the visual image 400 of a flame that is larger than the actual flame 120 that is produced, for example by the burner 126 and the pilot 124. The heat output of the actual flame 120 may be between 0 BTU and 20,000 BTU, or greater. The fireplace assembly 100 may be controlled manually or wirelessly using a remote controller 404, such that wireless data signals are received via a receiver/control device 402 of the fireplace assembly. The receiver/control device 402 is operatively coupled with the control module 112 as disclosed herein. The image 400 on the display device 108 may be controlled to switch between different background visual images (e.g., a video of a flame or other scenery, movie, slideshow, etc.).

The fireplace assembly as disclosed herein includes the benefits of electric fireplaces by simulating a large amount of flames with a manageable heat output, for the benefit of users who want larger flames but little to no heat output. The fireplace assembly may also include the benefits of gas fireplaces by providing additional heat output if so desired beyond the limitation of about 5,000 BTU (or about 5.3 MJ) for a typical electric fireplace, for example by allowing the heat output of at or above 20,000 BTU or 21.1 MJ, depending on the user's preference. For reference, a typical gas fireplace has a heat output range of from about 20,000 BTU or 21.1 MJ to about 60,000 BTU or 6.3 MJ, which may be greater than the preference of some users. Therefore, the fireplace assembly includes the benefits of allowing the user to adjust the heat output to within the range of about 0-20,000 BTU (about 0-21.1 MJ) or any other range as may be desirable, such as up to 30,000 BTU, 40,000 BTU, 50,000 BTU, etc., while providing a visual of a flame with greater heat output.

Additionally, the fireplace assembly may also include the benefits of providing technology to use alternative vent designs (vent-free, direct vent, Type B vent, etc.) or alternative fuel options (flammable gel, ethanol, biofuel, etc.). The internal airflow provides the benefits of keeping the electronic components cool when the fireplace assembly is operating at a higher range of heat output, such as above about 15,000 BTU/15.8 MJ or above about 20,000 BTU/21.1 MJ.

The glass barrier(s) beneficially provide protection from heat as well as provide airflow pathways for cooling the electronic components, especially the display. The front of the fireplace assembly may be removable to beneficially facilitate easy-to-service upgrade of the fireplace assembly through the front of the unit, providing access to the electronic components within the housing.

The fireplace assembly also provides the benefit of allowing the user the ability to control the image that is shown in the display. The fireplace assembly is beneficially not limited to internal use and may be used as an outdoor fireplace unit.

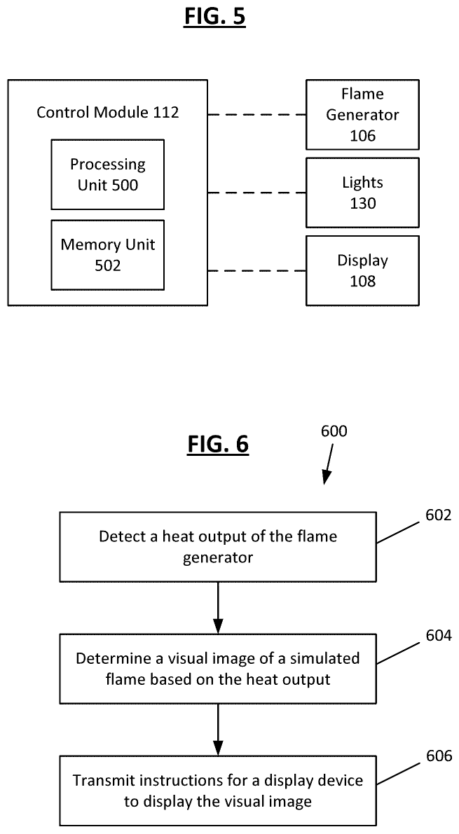

FIG. 5 shows an example of the control module 112 as disclosed herein. The control module 112 may be referred to as a controller and includes at least one processing unit 500 and at least one memory unit 502. The control module 112 is operatively coupled with the flame generator 106 and the display device 108, and in some examples is also coupled with the lights 130. In some examples, the control module 112 determines the visual image 400 based upon an amount of the heat output generated by the flame generator 106.

The processing unit 500 may include, for example, one or more of: a central processing unit (CPU), a microprocessor, a microcontroller, a digital signal processor (DSP), and/or one or more internal levels of cache. There may be one or more processors, such that the processor comprises a single CPU, or a plurality of processing units capable of executing instructions and performing operations in parallel with each other, commonly referred to as a parallel processing environment.

The memory unit 502 may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, one or more of: magnetic storage medium; optical storage medium; magneto-optical storage medium; read only memory (ROM); random access memory (RAM); erasable programmable memory (e.g., EPROM and EEPROM); flash memory; or other types of medium suitable for storing electronic instructions.

FIG. 6 shows a process 600 which may be performed by the control module 112, or the processing unit 500 of the control module 112, for displaying a visual image of a simulated flame, according to embodiments disclosed herein. In step 602, the control module detects a heat output of the flame generator of the fireplace assembly. In step 604, the control module determines the visual image of the simulated flame based on the detected heat output. In step 606, the control module transmits instructions to the display device for the display device to display the visual image.

In some examples, the simulated flame is a simulation of a flame having a heat output that is greater than the heat output of the flame generator that is detected by the control module, and the simulated flame may have a heat output of greater than 20,000 BTU or 21.1 MJ. The detecting of the heat output may be facilitated using one or more sensors that is coupled with the flame generator, including but not limited to thermometers. The determination of the visual image may be facilitated based on analyzing the measurements taken by the sensors. The control module may have access a database, such as a remote server or the memory unit, which stores thereon a set of visual images in the form of data that correspond with (or are paired with) different values or amounts of heat output.

For example, the data of a visual image showing a larger flame may be associated with a larger heat output measurement or value, such that when a similar measurement or value of heat output is detected (assuming the detected heat out is “X” BTU), the control module may choose or select the visual image that corresponds to a greater heat output (for example, a visual image that is associated with “Y” BTU, where X and Y are different numbers, and X<Y) to be displayed on the display device. As such, the process 600 beneficially provides the users with an option to enjoy the visual image with a theoretical heat output of “Y” BTU, while in actuality only receiving a flame that is measured at “X” BTU, where the value of X is less than the value of Y.

Numerous characteristics and advantages have been set forth in the preceding description, including various alternatives together with details of the structure and function of the devices and/or methods. Moreover, the scope of the various concepts addressed in this disclosure has been described both generically and with regard to specific examples. The disclosure is intended as illustrative only and as such is not intended to be exhaustive. It will be evident to those skilled in the art that various modifications may be made, especially in matters of structure, materials, elements, components, shape, size, and arrangement of parts including combinations within the principles of the disclosure, to the full extent indicated by the broad, general meaning of the terms in which the appended claims are expressed. To the extent that these various modifications do not depart from the spirit and scope of the appended claims, they are intended to be encompassed therein.

What is claimed is:

1. A fireplace assembly comprising:
a housing defining an airflow space and an inner chamber;
one or more fans disposed in the housing to facilitate airflow through the airflow space;
a flame generator disposed in the inner chamber and capable of generating a flame with a maximum heat output of at least 20,000 BTU (British Thermal Units) or 21.1 MJ (megajoules);
a display device disposed in the housing and configured to display a visual image in front of or behind the flame generator;
one or more glass panels disposed in the housing to at least partially define the airflow space to facilitate the airflow; and
a control module operatively coupled with the display device and disposed within the airflow space, wherein the airflow through the airflow space is configured to control temperature within the airflow space.

2. The fireplace assembly of claim 1, wherein the visual image is an image of a simulated flame with a heat output of greater than the maximum heat output of the flame generator.

3. The fireplace assembly of claim 1, wherein the flame generator includes a fuel source, a pilot, and a burner.

4. The fireplace assembly of claim 3, wherein the fuel source uses any one or more of: gas, electricity, flammable gel, ethanol, or biofuel.

5. The fireplace assembly of claim 1, further comprising a floor shield disposed in the inner chamber, wherein the control module is operatively coupled with one or more lights disposed underneath the floor shield.

6. The fireplace assembly of claim 1, wherein the housing includes an inflow vent and an outflow vent.

7. The fireplace assembly of claim 6, wherein a floor of the inner chamber is aligned with the inflow vent.

8. The fireplace assembly of claim 7, wherein the floor of the inner chamber is level with an upper part of the inflow vent.

9. The fireplace assembly of claim 1, wherein the housing includes a glass air shield disposed at a front portion of the housing.

10. The fireplace assembly of claim 9, wherein a floor of the inner chamber is aligned with a bottom portion of the glass air shield.

11. The fireplace assembly of claim 9, wherein a floor of the inner chamber is disposed below a bottom portion of the glass air shield.

12. The fireplace assembly of claim 1, wherein the housing includes a mesh door disposed at a front portion of the housing.

13. The fireplace assembly of claim 1, wherein the housing includes a power source for the display device and the control module.

14. The fireplace assembly of claim 1, further comprising a fire media tray disposed in the housing, and fire media disposed in the fire media tray.

15. The fireplace assembly of claim 1, wherein the one or more glass panels includes a plurality of glass panels that are disposed such that a space between two of the plurality of glass panels defines a portion of the airflow space and the airflow is facilitated between the two of the plurality of glass panels.

16. The fireplace assembly of claim 1, further comprising a receiver operatively coupled with the control module and configured to receive wireless data signals from a remote controller.

17. The fireplace assembly of claim 1, wherein the control module includes a processing unit and a memory unit, wherein the processing unit is operatively coupled with the flame generator and the display device, and the processing unit determines the visual image based upon an actual amount of heat output of the flame generator.

18. A method of displaying a visual image of a simulated flame, the method comprising:
detecting, by a control module of a fireplace assembly, a heat output of a flame generator of the fireplace assembly;
determining, by the control module, the visual image of the simulated flame based on the detected heat output; and
transmitting, by the control module to a display device, instructions for the display device to display the visual image.

19. The method of claim 18, wherein the simulated flame is a simulation of a flame having a heat output that is greater than the heat output of the flame generator that is detected by the control module.

20. The method of claim 19, wherein the simulated flame has a heat output of greater than 20,000 BTU or 21.1 MJ.
